(19) United States
(12) Patent Application Publication
(10) Pub. No.: US 2009/0121818 A1
(43) Pub. Date: May 14, 2009

(54) AIR CORE INDUCTOR INCLUDING A FLUX INHIBITING MEMBER

(75) Inventor: Robert Gregory WAGONER, Roanoke, VA (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/939,102

(22) Filed: Nov. 13, 2007

(51) Int. Cl. H01F 27/36; H01F 27/10

(52) U.S. Cl. 336/58; 336/62; 336/84 M

(57) ABSTRACT

An air core inductor includes an inductor member formed in a plurality of coils. The inductor member includes a first end portion, a second end portion and a hollow core portion. The air core inductor also includes at least one stray flux inhibiting member provided on one of the first and second end portions of the inductor member. The stray flux inhibiting member blocks stray magnetic flux emanating from the air core inductor.

### BACKGROUND OF THE INVENTION

The present invention pertains to the art of air core inductors and, more particularly, to an air core inductor having a flux inhibiting member.

An inductor is usually constructed as a coil of conducting material, typically copper, wrapped around a core having a permeability higher than air. Generally, the core is a ferromagnetic material that is cylindrical or annular in shape. The ferromagnetic material confines a magnetic field closely to the inductor thereby increasing inductance. However, inductors wrapped around a ferromagnetic core become saturated at high currents. At saturation, any additional increase in magnetization force does not produce an increase in flux density. That is, the permeability of the core goes to zero and the inductor no longer functions.

Inductor malfunction resulting from saturation can be addressed by using an air core inductor. An air core inductor, is constructed as a coil of conducting material, typically copper, having no internal core. With air as the core, saturation is no longer an issue and the inductor can handle, for example, fault currents that can exceed operating parameters by a factor of 100. However, one drawback that exists with air core inductors is the generation of stray magnetic flux. Without a core to contain and confine the magnetic flux, stray magnetic fluxes pass from the inductor. This stray flux can cause electrical noise related problems in sensitive electrical circuits. Also, when the stray flux impacts an electrically conductive material, a phenomenon known as induction heating occurs.

At high currents, induction heating will overheat neighboring components, peel paint from adjacent cabinetry or otherwise damage any electrically conductive structure in close proximity. As a consequence, air core inductors designed for high current configurations must be isolated from adjacent electronic components, and either maintained in the open, away from neighboring electrically conductive structure, or housed in large cabinets having adequate free space.

### BRIEF DESCRIPTION OF THE INVENTION

In accordance with one aspect of the invention, an air core inductor is provided. The air core inductor includes an inductor portion formed into a plurality of coils that define an inductor member. The inductor member includes a first end portion, a second end portion and a hollow core portion. In addition, the air core inductor includes at least one stray flux inhibiting member provided on one of the first and second end portions of the inductor member. The stray flux inhibiting member blocks stray magnetic flux emanating from the air core inductor.

In accordance with another aspect of the invention, a method of inhibiting stray flux emanating from an air core inductor is provided. The air core inductor includes an inductor portion formed in a plurality of coils that define an inductor member having a first end portion, a second end portion and a hollow core portion. The method includes passing an electrical current through the inductor member to create a magnetic flux including a stray magnetic flux portion and blocking the stray magnetic flux portion from passing from the air core inductor through at least one of the first and second end portions of the inductor member with a stray flux inhibiting member.

It should be appreciated the present invention provides an air core conductor that can control high electrical currents yet be placed adjacent to other electrically conductive structure. That is, the present invention blocks stray magnetic flux that might otherwise pass from the air core inductor and detrimentally affect neighboring electrically conductive structure. Additional objects, features and advantages of various aspects of the present invention will become more readily apparent from the following detailed description of illustrated aspects of the invention when taken in conjunction with the drawings wherein like reference numerals refer to corresponding parts in the several views.

### BRIEF DESCRIPTION OF THE DRAWINGS

FIG. 1 is an upper left perspective view of an inductor system employing an air core inductor constructed in accordance with one aspect of the present invention;

FIG. 2 is an upper right perspective view of the air core inductor of FIG. 1; and

FIG. 3 is an exploded view of the air core inductor of FIG. 2.

### DETAILED DESCRIPTION

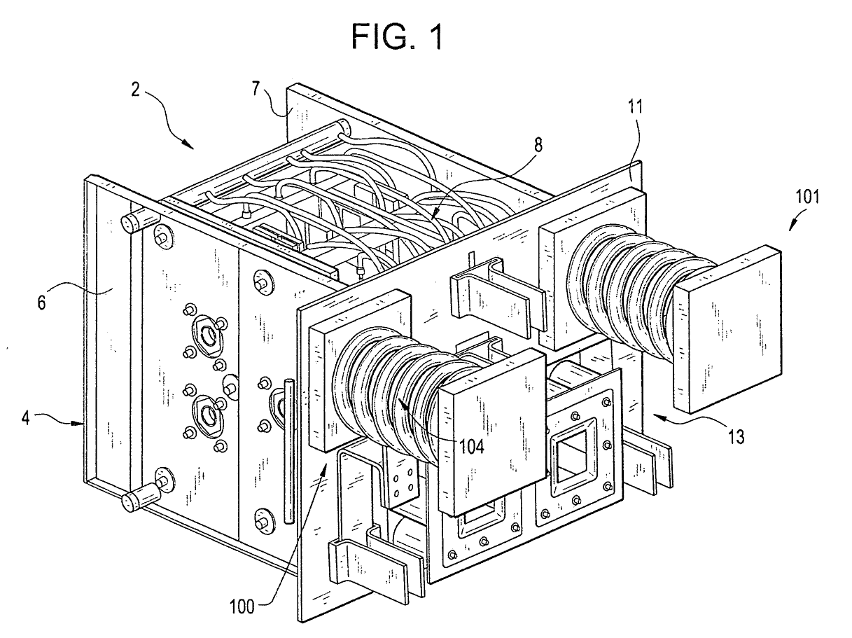

With initial reference to FIG. 1, an inductor system 2 includes a housing 4 having first and second wall members 6 and 7 that define an electrical component section 8. As shown, electrical component section 8 houses various components (not separately labeled) of inductor system 2. Housing 4 is also shown to include a mounting plate 11 that defines an inductor portion 13 of inductor system 2. Inductor portion 13 includes first and second air core inductors 100 and 101 constructed in accordance with one aspect of the present invention as will be discussed more fully below. At this point it should be understood that inductor system 2 is but one exemplary application for air core inductors 100 and 101. In any event, as each air core inductor 100, 101 is identical, a detailed description will follow with respect to air core inductor 100 with an understanding that air core inductor 101 is similarly constructed.

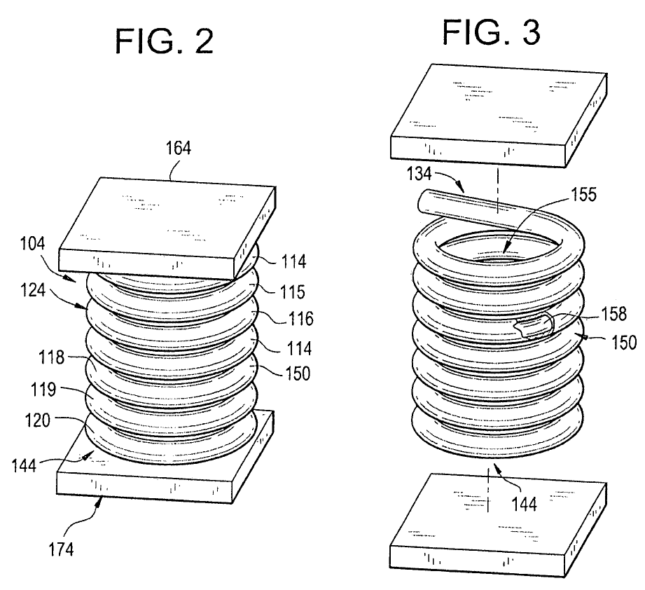

As best shown in FIGS. 2 and 3, air core inductor 100 includes an inductor portion 104 having a plurality of coils 114-120 that define an inductor member 124. Inductor member 124 includes a first end portion 134 a second end portion 144 and an intermediate portion 150 that collectively define a hollow or air core portion 155. With this construction, it should be appreciated that inductor member 124 defines an air core inductor. In accordance with one aspect of the invention, inductor member 124 is formed from a solid core electrical conductor such as copper. In accordance with another aspect of the present invention, inductor member 124 is a hollow core electrical conductor having an interior conduit portion 158 such as illustrated in FIG. 3. Interior conduit portion 158 serves as a cooling fluid conduit for air core conductor 100. More specifically, during operation, particularly at high current ratings, air core inductor 100 generates a considerable amount of heat. In order to dissipate the heat, a cooling fluid, such as water, is passed through interior conduit portion 158.

In addition to producing heat, the application of an electrical current between any two of the plurality of coils 114-120 generates a magnetic field about inductor member 124. In manner known in the art, the magnetic flux flows through hollow core portion 155, out through first end portion 134, back along inductor member 124 and into second end portion 144. Without a ferromagnetic core, there is nothing to contain the magnetic flux generated by the current flowing through inductor portion 104. In order to block or substantially inhibit the magnetic flux from exiting first end portion 134 and entering second end portion 144 air core inductor 100 includes first and second flux inhibiting members 164 and 174.

As shown, first and second flux inhibiting members 164 and 174 are positioned adjacent first and second end portions 134 and 144 respectively. First and second flux inhibiting members 164 and 174 block stray magnetic flux and establish a shorter magnetic path for air core inductor 100. First and second flux inhibiting members 164 and 174 are preferably formed from a ferrous material such as ferrite, iron, steel and alloys thereof. However, other materials having qualities that would inhibit the magnetic flux could also be employed. As illustrated in Table 1.1 reproduced below, when in place, flux inhibiting members 164 and 174 reduce B-field or stray flux, at a point located 200 mm centered directly above first end portion 134 induction by a factor of about 6.47 times. In addition, the shorter magnetic path causes an induction increase for air core inductor 100 by a factor of approximately 1.1 times. Of course, above a saturation flux point of stray flux inhibiting members 164 and 174, inductance would return to the original inductance of induction member 124, i.e., in the example below, 4.323 μH. Of course, B-field density and induction will vary with different coil and flux inhibiting member geometries.

TABLE 1.1

| | Standard Air Core | Air Core Inductor with |
|---|---|---|
| | Inductor | Flux Inhibiting Members |
| Wire | 50 mm diameter Copper | 50 mm diameter Copper |
| Turns | 6 | 6 |
| Inductance (μH) | 4.323 | 4.796 |
| Current flow (amps) | 2800 amps | 2800 |
| B Field density | 1.1E−2 | 1.7E−3 |
| (tesla) | | |

At this point it should be appreciated the present invention provides an air core inductor that does not spew stray magnetic flux about adjacent areas. That is, the present invention blocks or substantially inhibits stray flux emanating from air core inductor 100. As a result, air core inductor 100 can be placed in close proximity with other electrical and electrically conducting components without fear of damage caused by induction heating effects. In this manner, systems that employ air core inductors, and particularly high current rated air core inductors, can be constructed that are more compact than arc currently possible while still providing control over high electrical currents. In any event, it should be understood that air core inductor 100 can be formed in a variety of configurations and shapes. In addition, the number coils employed in forming the air core inductor can vary. Also, while shown with two stray flux inhibiting members, the air core inductor can be provided with a single stray flux inhibiting member.

In general, this written description uses examples to disclose the invention, including the best mode, and also to enable any person skilled in the art to practice the invention, including making and using any devices or systems and performing any incorporated methods. The patentable scope of the invention is defined by the claims, and may be includes other examples that occur to those skilled in the art. Such other examples are intended to be within the scope of the present invention if they have structural elements that do not differ from the literal language of the claims, or if they include equivalent structural elements with insubstantial differences from the literal language of the claims.

1. An air core inductor comprising:
an inductor member including a plurality of coils having a first end portion, a second end portion and a hollow core portion; and
at least one stray flux inhibiting member provided on one of the first and second end portions of the inductor member, the at least one flux inhibiting member blocking stray magnetic flux emanating from the air core inductor.

2. The air core inductor according to claim 1, wherein the stray flux inhibiting member is formed from a ferrous material.

3. The air core inductor according to claim 2, wherein the ferrous material is ferrite.

4. The air core inductor according to claim 2, wherein the ferrous material is iron.

5. The air core inductor according to claim 2, wherein the ferrous material is steel.

6. The air core inductor according to claim 1, wherein the at least one stray flux inhibiting member is first and second stray flux inhibiting members provided on respective ones of the first and second end portions of the inductor member.

7. The air core inductor according to claim 1, wherein the inductor member is formed from a solid electrical conductor.

8. The air core inductor according to claim 1, wherein the inductor member is a hollow electrical conductor having an internal conduit portion.

9. The air core inductor according to claim 8, wherein the internal conduit portion of the hollow electrical conductor is adapted to pass a flow of coolant.

10. The air core inductor according to claim 9, wherein the coolant is water.

11. A method of inhibiting stray flux emanating from an air core inductor having an inductor member formed in a plurality of coils including a first end portion, a second end portion and a hollow core portion, the method comprising:
passing an electrical current through the inductor member to create a magnetic flux including a stray magnetic flux portion; and
blocking the stray magnetic flux portion from passing from the air core inductor through at least one of the first and second end portions of the inductor member with a stray flux inhibiting member.

12. The method of claim 11, wherein the stray flux inhibiting member is formed from a ferrous material.

13. The method of claim 12, wherein the ferrous material that forms the stray flux inhibiting member is ferrite.

14. The method of claim 12, wherein the ferrous material that forms the stray flux inhibiting member is iron.

15. The method of claim 12, wherein the ferrous material that forms the stray flux inhibiting member is steel.

16. The method of claim 12, wherein blocking the stray magnetic flux portion passing from the air core inductor through at least one of the first and second end portions of the inductor member includes blocking the stray magnetic flux portion from passing through both the first and second end portions.

17. The method of claim 11, further comprising: passing a coolant through the inductor member to cool the air core inductor.

18. The method of claim 17, wherein passing a coolant through the inductor member includes passing water through the plurality of coils.
